(19) United States
(12) Patent Application Publication
(10) Pub. No.: US 2024/0354664 A1
(43) Pub. Date: Oct. 24, 2024

(54) Method and Computer Program for Assigning an Electric Vehicle to a User

(71) Applicant: ZF Friedrichshafen AG, Friedrichshafen (DE)

(72) Inventors: Alma Pröbstl, Bobingen (DE); Jens Kastens, Tettnang (DE); Nicolas Blum, Julbach (DE)

(21) Appl. No.: 18/292,142

(22) PCT Filed: Jul. 4, 2022
(86) PCT No.: PCT/EP2022/068384

§ 371 Date: Jan. 25, 2024

(30) Foreign Application Priority Data
Jul. 26, 2021 (DE) 10 2021 208 004.9

(51) Int. Cl. G06Q 10/02; G06Q 50/43

(52) U.S. Cl. CPC G06Q 10/02; G06Q 50/43

(57) ABSTRACT

A method for assigning an electric vehicle (20, 22, 24) to a user includes: receiving a request from the user via a receiving device stating that the user needs an electric vehicle (20, 22, 24), the request including usage information regarding the planned use of the electric vehicle (20, 22, 24); determining a target state of charge of a battery (22) of at least one available electric vehicle (20, 22, 24) depending on the usage information; determining an actual state of charge of the battery (22) of the electric vehicle (20, 22, 24); and assigning the electric vehicle (20, 22, 24) to the user when the determined actual state of charge is greater than or equal to the determined target state of charge.

### CROSS-REFERENCE TO RELATED APPLICATIONS

The present application is related is a U.S. national phase application of PCT/EP2022/068384 filed on Jul. 4, 2022 and has right of priority to German Patent Application No. DE102021208004.9 filed on Jul. 26, 2021, both of which are incorporated by reference in their entirety for all purposes.

### TECHNICAL FIELD

The invention relates generally to a method and to a computer program for assigning an electric vehicle to a user.

### BACKGROUND

Electric vehicles obtain drive energy from at least one battery, which is located in the corresponding electric vehicle. This type of electric vehicle can be, for example, an electric truck, an electric car, an electric bicycle, or an electric scooter. This type of battery can be charged at a private or public charging device, for example, at a wallbox or a charging station.

In vehicle fleets which include multiple electric vehicles, for example, vehicle fleets of companies, car rental companies, or car-sharing operations, it is routine to only issue electric vehicles to users, in particular drivers, which have a maximum state of charge (SOC) of the batteries of the electric vehicles. In other words, only the electric vehicles that are fully charged are loaned. This is ensured, among other things, by requiring the users to return electric vehicles fully charged or by fully charging returned electric vehicles if the electric vehicles are not fully charged.

A high state of charge, for example, over ninety percent (90%) and/or with a fully charged battery, can negatively affect a service life of the battery when there are relatively long downtimes, for example, over six (6) or twelve (12) hours. The above-described approach to loaning out electric vehicles regularly results in such long downtimes with such states of charge. In the medium to long term, this results in the batteries of the entire electric vehicle fleet aging faster than average and needing to be replaced relatively early. This results in a large amount of work required and high costs for the vehicle fleet operator. The vehicle fleet operator therefore experiences a loss of fleet value, in particular of the fleet electric vehicles, when the batteries are permanently at a high state of charge or are operated only within high state of charge ranges.

For the rest, charging processes up to the maximum state of charge require a relatively long period of time as compared to only partial charging, since the charging currents are lowered in order to protect the batteries, especially when the states of charge are already relatively high. As a result, a utilization of the electric vehicle fleet decreases due to the requirement that the electric vehicles must have a state of charge of one hundred percent (100%) when loaned out. This results in higher operating costs to the fleet operator. In addition, the user therefore has only a relatively small number of electric vehicles in his/her surroundings from which to choose. This situation is unsatisfactory for the fleet operator and for the users.

### BRIEF SUMMARY

Example aspects of the invention provide a method and a computer program for assigning an electric vehicle to a user, which contribute, in an easy way, to a particularly high service life of a battery of the electric vehicle.

One example aspect of the invention relates to a method for assigning an electric vehicle to a user. In example embodiments, the method includes receiving a request from the user stating that the user needs an electric vehicle, the request including usage information regarding the planned use of the electric vehicle. The request is received by via a receiving device, for example, via a server of the vehicle fleet operator of the electric vehicle. The usage information includes energy requirement information, by which an energy requirement of the electric vehicle can be determined for the usage planned by the user. The usage information can include, for example, need information, distance information regarding a planned distance, and/or route information regarding a planned route. The need information can include, for example, a pick-up location for picking up the electric vehicle, a return location for returning the electric vehicle, a pick-up time and/or a return time. The distance information can include, for example, a route length of the planned distance. The route information can include, for example, a starting location, a destination, a predicted route, gradients of inclines along the route, types of roads to be used (country road, expressway, highway, road in an enclosed town), a duration of the route, and/or, if the route has already been traveled, an energy requirement for the planned route. The user can send the request, for example, by a mobile device of the user, for example, via an app, and/or via the Internet. Alternatively, the user can communicate the request to an employee of the fleet operator via telephone, and the employee can enter the request into the computer system of the fleet operator.

Example aspects of the method also include determining a target state of charge of a battery of at least one available electric vehicle depending on the usage information. For example, the target state of charge of the battery can be determined depending on the distance information, in particular, the route length of the planned distance, and/or depending on the route information, for example, depending on inclines along the route and/or the types of roads which are used. For example, relative numerous and/or steep inclines, a long distance, and/or journeys within closed towns result in a relatively high target state of charge. In contrast thereto, few or no inclines, a short distance, and/or journeys on country roads result in a relatively low target state of charge.

Example aspects of the method also include determining an actual state of charge of the battery of the electric vehicle. The actual state of charge can be stored on a server of the fleet operator, the server being connected to the computer system of the fleet operator. For this purpose, the actual state of charge can be retrieved from the electric vehicle in advance by data transmission and stored on the server. Alternatively, the actual state of charge can be retrieved directly from the electric vehicle. The actual state of charge is preferably determined by a voltage measuring device aboard the electric vehicle and subsequently transmitted to the server, for example, by a wireless data transmission device.

Example aspects of the method also include assigning the electric vehicle to the user when the determined actual state of charge is greater than or equal to the determined target state of charge. The successful assignment can be confirmed with the user, for example, by an appropriate message, for example, on the mobile device of the user. Once the assignment has been made, the electric vehicle is ready for the user and is no longer available for other users until the user returns the electric vehicle.

Due to the method, an electric vehicle which does not have a high state of charge, for example, below ninety-five percent (95%), ninety percent (90%), or eighty percent (80%), can be assigned to the user. This contributes to the fleet operator not needing to keep any, or at least only a few, electric vehicles in stock which have a high state of charge. Therefore, situations in which electric vehicles have relatively long downtimes, for example, over six (6) or twelve (12) hours, can be avoided or at least reduced. In other words, situations which negatively affect the service life of the batteries of the electric vehicles can be avoided or at least reduced. In the medium to long term, this results in the batteries of the entire electric vehicle fleet having a particularly long service life and relatively rarely needing to be replaced. This contributes to a low amount of work required and low costs for the vehicle fleet operator. Therefore, the vehicle fleet operator can keep the technical state and value of the fleet, in particular the fleet electric vehicles, at a high level for a long period of time.

For the rest, charging processes up to a target state of charge which is below the maximum state of charge can be carried out relatively quickly as compared to a maximum charge, since no protective mechanisms are necessary for protecting the batteries. As a result, a utilization of the electric vehicle fleet can be particularly high. This results in low operating costs to the fleet operator. In addition, the user therefore has a relatively large number of electric vehicles in the user surroundings from which to choose.

According to one example embodiment, the target state of charge is determined such that the user can use the electric vehicle as planned without having to charge the electric vehicle. This contributes to a particularly high level of comfort for the user.

According to one alternative example embodiment, the target state of charge is determined such that the user must charge the electric vehicle when the electric vehicle is utilized in accordance with the planned use, if the usage information suggests that the charging process does not adversely affect the user during the planned use of the electric vehicle.

According to one example embodiment, the usage information includes personal information which is representative of a previous driving behavior of the user, and the target state of charge of the battery of the available electric vehicle is determined depending on the personal information. The previous driving behavior can relate, for example, to whether the driving style of the user is economical, normal or sporty. The energy requirement and, therefore, the target state of charge can be determined to be higher when the driving style of the user is sporty than when the driving style of the user is economical. Taking the personal information into account when determining the target state of charge can contribute to the target state of charge being particularly precisely determined. Preferably, a state-of-charge reserve is taken into account in the determination of the target state of charge in order to reduce the probability of an additional charging process.

According to one example embodiment, the target state of charge of the battery is determined depending on vehicle information regarding the available electric vehicle. The vehicle information can include, for example, a size, a weight, a vehicle type, a previous average consumption, a power, and/or a battery capacity. For example, a higher energy requirement and, therefore, a greater target state of charge can be determined in the case of a large size, a high weight, an SUV, a truck or a van, a high previous average consumption and/or a high power than in the case of a small size, a low weight, a mid-size car or a small car, a low previous average consumption and/or a low power. The battery capacity can be taken into account, for example, in such a way that the user is assigned an electric vehicle, the battery capacity of which suffices for the desired use such that the user does not need to charge the electric vehicle. Taking the vehicle information into account when determining the target state of charge can contribute to the target state of charge being particularly precisely determined.

According to one example embodiment, upon receipt of the user request and prior to determining the target state of charge of the battery, it is determined whether the electric vehicle is available depending on the usage information and depending on the usage plan for the electric vehicle. The usage plan indicates, for example, where, when, and for how long the electric vehicle is available. The usage plan can be stored, for example, in the computer system and/or on the server of the fleet operator. The usage plan can contribute to preventing the electric vehicle from being assigned to two different users at the same time.

According to one example embodiment, the method includes determining, upon receipt of the user request and prior to determining the target state of charge of the battery, at least two available electric vehicles from a pool of electric vehicles depending on the usage information and depending on a booking plan for pool. In this case, when determining the target state of charge of the battery of the at least one electric vehicle, the target state of charge of the batteries of the at least two electric vehicles can be determined depending on the usage information, wherein the one electric vehicle can be included among the two electric vehicles. In short, the target state of charge of the batteries of the at least two electric vehicles is determined depending on the usage information. The actual state of charge of the batteries of the at least two electric vehicles is determined and the user is assigned the electric vehicle, the determined actual state of charge of which is greater than or equal to the determined target state of charge. This can contribute to assigning the suitable electric vehicle to the user, conserving the batteries of the electric vehicles and simultaneously utilizing the electric vehicle fleet particularly well, preferably optimally. The booking plan can include, for example, a usage plan for each electric vehicle in the pool. In particular, the booking plan can indicate, for example, which electric vehicles are available where, when, and for how long.

According to one example embodiment, the target states of charge of the batteries are determined depending on the vehicle information regarding the available electric vehicles. Taking the vehicle information into account when determining the target state of charge can contribute to the target states of charge being particularly precisely determined.

According to one example embodiment, if the actual states of charge of more than one electric vehicle are greater than or equal to the determined target state of charge, the user is assigned the electric vehicle having the lowest state of charge. This allows the suitable electric vehicles having higher target states of charge to be available for one or more other user(s) who may have a higher energy requirement. This can also contribute to optimal utilization of the fleet.

According to one example embodiment, if the actual states of charge of more than one electric vehicle are greater than or equal to the determined target state of charge, the user is assigned the electric vehicle having the highest state of charge. This can contribute to avoiding particularly high states of charge and the associated damage to the batteries, in particular during long downtimes, since downtimes are reduced due to the use of the electric vehicles.

According to one example embodiment, if the actual states of charge of more than one electric vehicle are greater than or equal to the determined target state of charge, the user is assigned the electric vehicle which has not been used for the longest period of time. This can contribute to wear of the vehicles being uniformly distributed over the pool of electric vehicles. Furthermore, this can contribute to reducing or avoiding particularly long downtimes and thus the risk of particularly long downtimes when states of charge are high.

According to one example embodiment, the battery is a lithium-ion battery. In this context, it is particularly advantageous to avoid long downtimes when states of charge are high.

One example aspect of the invention relates to a computer program for assigning an electric vehicle to a user, which, when carried out by a processor of a computer, for example, of the computer system of the fleet operator, causes the method of one of the example embodiments to be implemented. The computer program can be stored on a computer-readable medium. A computer-readable medium can be a hard drive, a USB storage device, a RAM, a ROM, an EPROM or a FLASH drive. A computer-readable medium can also be a data communication network, such as, for example, the Internet, which makes it possible to download a program code.

It is understood that the example features, embodiments, and advantages of the method as described above and in the following can also be example features, embodiments, and advantages of the battery control unit, of the electric vehicle and/or of the computer program, and vice versa.

### BRIEF DESCRIPTION OF THE DRAWINGS

Exemplary embodiments of the invention are described in detail in the following with reference to the attached figures.

FIG. 1 shows one exemplary embodiment of an electric vehicle.

FIG. 2 shows one exemplary embodiment of a pool of electric vehicles.

FIG. 3 shows one exemplary embodiment of a networked system for assigning an electric vehicle to a user.

FIG. 4 shows a flow chart of one exemplary embodiment of a method for assigning an electric vehicle to a user.

The reference characters used in the figures and their meaning are summarized in the list of the reference characters. Identical or similar parts are always labeled with the same reference characters.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

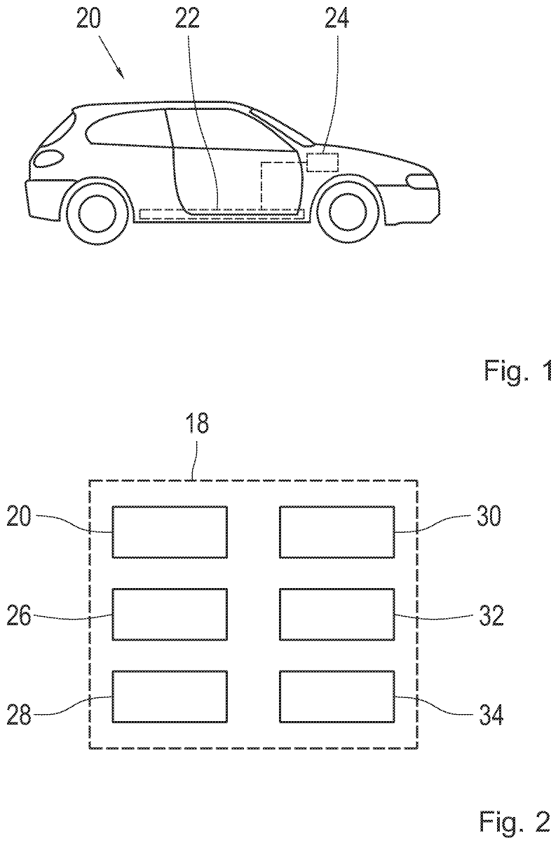

FIG. 1 shows one exemplary embodiment of an electric vehicle 20. The electric vehicle 20 has a battery 22 and a battery control unit 24. The battery 22 is, for example, a lithium-ion battery. In the example shown in FIG. 1, the electric vehicle 20 is an electric car. Alternatively, the electric vehicle 20 can be, for example, an electric truck, an electric bicycle, or an electric scooter.

For example, the electric vehicle 20 is in the parked mode. The parked mode can be characterized, for example, in that a parking brake (not shown) of the electric vehicle 20 is active, in that “P” of an automatic transmission (not shown) of the electric vehicle 20 has been selected, and/or in that the electric vehicle 20 is switched off. Furthermore, the battery 22 can be fully charged, in other words, have a maximum state of charge, or can have at least a high state of charge. The high state of charge can be, for example, between eighty percent (80%) and one hundred percent (100%), for example between ninety percent (90%) and ninety-eight percent (98%), for example, between ninety-four percent (94%) and ninety-six percent (96%). For example, the high state of charge is eighty percent (80%), ninety percent (90%), or ninety-five percent (95%). If the electric vehicle 20 should have a long downtime at this high state of charge, this can contribute to a shortening of the service life of the battery 22.

FIG. 2 shows one exemplary embodiment of a pool 18 of electric vehicles 20, 26, 28, 30, 32, 34, which each largely correspond, for example, to the electric vehicle 20 described above. The pool 18 is at least a portion of a vehicle fleet. The vehicle fleet can include, for example, a fleet of company vehicles and/or rental vehicles. For example, the electric vehicles 20, 26, 28, 30, 32, 34 can be company vehicles or rental vehicles.

Previously it was common for the electric vehicles 20, 26, 28, 30, 32, 34 to be returned by and/or issued to employees of the company or customers of the car rental company or the car-sharing company, to which the fleet 18 belongs, fully charged, even when it was clear that the corresponding range of the electric vehicle 20, 26, 28, 30, 32, 34 was not needed at all. This regularly resulted in unnecessarily long downtimes of the electric vehicles 20, 26, 28, 30, 32, 34 with a fully charged battery 22. This contributed to unnecessary wear and thus to a shortened service life of the corresponding batteries 22. This can be avoided or at least limited by example aspects of the method explained with reference to the following figures.

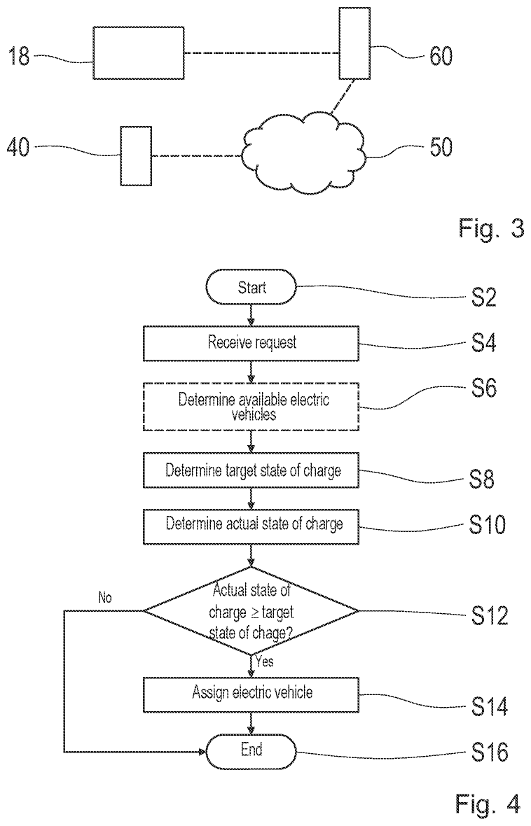

FIG. 3 shows one exemplary embodiment of a networked system for increasing a service life of a battery of an electric vehicle. The networked system includes the pool 18, a mobile device 40 of a potential user of one of the electric vehicles 20, 26, 28, 30, 32, 34, the Internet 50, and a server 60 of the fleet operator. The fleet operator can be a company which maintains the fleet 18 for employees, or a car rental company or a car-sharing company which maintains the fleet 18 for customers. The user can therefore be an employee of the company or a customer of the car rental company or of the car-sharing company. The mobile device 40 can be, for example, a mobile phone or a tablet computer of the user. The server 60 can include a computer system of the fleet operator or communicate therewith.

The pool 18, in particular the individual electric vehicles 20, 26, 28, 30, 32, 34, can be connected to the server 60 directly or, alternatively, via the Internet 50. The mobile device 40 can be directly connected to the Internet 50. The mobile device 40 can be connected to one of the electric vehicles 20, 26, 28, 30, 32, 34 and/or to the server 60 via the Internet 50. The server 60 can be directly connected to the Internet 50. The connections between these individual components of the system can each be exclusively wired or exclusively wireless, or can each include wired and wireless sub-connections. The connections each allow for communication between the two corresponding components.

The system is used to avoid long downtimes of the electric vehicles 20, 26, 28, 30, 32, 34 having a high state of charge and thus to contribute to a long service life of the corresponding batteries 22. Resources of the electric vehicles 20, 26, 28, 30, 32, 34, of the mobile device 40, and/or of the server 60 can be used for this purpose. For example, data can be used which are stored in the electric vehicles 20, 26, 28, 30, 32, 34 and/or are generated thereby, the data being stored on the mobile device 40 and/or generated thereby, and/or data which are stored on the server 60 or the computer system of the fleet operator. These data can be, for example, personal information about the user, the information being, for example, representative of a behavior of the user, for example, the user driving behavior, for example, economical, normal or sporty, of a state of charge of the electric vehicles 20, 26, 28, 30, 32, 34, and/or of a usage behavior of the electric vehicle 20, for example, a charging plan.

The electric vehicles 20, 26, 28, 30, 32, 34 can communicate with the server 60, the computer system and/or the mobile device 40 in order to exchange the data and/or further data with the server 60, the computer system and/or the mobile device 40, to send the data and/or further data thereto and/or to receive the data and/or further data therefrom. Furthermore, the electric vehicles 20, 26, 28, 30, 32, 34 can communicate with the server 60, the computer system, and/or the mobile device 40 in order to use processing resources, for example, one or more processor(s), of the server 60 and/or of the mobile device 40, for example, within the sense of a distributed processing of the data.

A method which can use the system, in particular the server 60 and/or the computer system of the fleet operator, to avoid long downtimes of the electric vehicles 20, 26, 28, 30, 32, 34 having a high state of charge and thus to contribute to a long service life of the corresponding batteries 22 is explained in the following with reference to FIG. 4.

FIG. 4 shows a flow chart of one exemplary embodiment of a method for assigning an electric vehicle 20, 26, 28, 30, 32, 34 to a user. The method can be carried out, for example, by the server 60.

The method can be started in a step S2. For example, the method can be started when the fleet operator begins work. In the step S2, variables can be initialized, if necessary.

In a step S4, a request is received from the user. The request includes, among other things, usage information regarding the planned use, on the basis of which an energy requirement of the electric vehicle 20, 26, 28, 30, 32, 34, which is to be loaned to the user, can be determined. This information can be characterized as energy requirement information and/or, for example, include a planned distance, a planned route, and/or a starting location and/or a destination. Furthermore, the request can include personal information about the user, for example, user previous usage behavior and/or driving behavior. Additionally or alternatively, the personal information can also be stored on the server 60.

In an optional step S6, a check is carried out to determine which electric vehicles 20, 26, 28, 30, 32, 34 are available, in principle, in particular regardless of the state of charge. This check can be carried out, for example, with reference to a booking plan for the fleet 18, in particular with reference to usage plans for the electric vehicles 20, 26, 28, 30, 32, 34. The booking plan can include, for example, which electric vehicles 20, 26, 28, 30, 32, 34 are currently not being used and/or when which of the electric vehicles 20, 26, 28, 30, 32, 34 has already been reserved.

In a step S8, the target states of charge of the batteries 22 of the available electric vehicles 20, 26, 28, 30, 32, 34 are determined, for example, by the server 60. Vehicle information can be taken into account in the determination of the target states of charge, for example, the average energy consumption of the corresponding vehicles 20, 26, 28, 30, 32, 34, the energy requirement information and/or, if available, the personal information about the user, for example, regarding his/her previous driving behavior.

In a step S10, the actual states of charge of the batteries 22 of the available electric vehicles 20 are determined, for example, by the server 60. The actual states of charge can be determined, for example, by control devices of the electric vehicles 20, 26, 28, 30, 32, 34. The control device can query the corresponding state of charge, for example, from the battery control unit 24 of the corresponding electric vehicle 20. Alternatively, the state of charge can be determined by the battery control unit 24 of the corresponding electric vehicle 20 or can already be stored on the server 60. The state of charge can also be referred to as State of Charge (SOC).

In a step S12, a check is carried out for each of the available electric vehicles 20, 26, 28, 30, 32, 34 to determine whether the particular determined state of charge is greater than the determined target state of charge. If the condition of the step S12 has been met for one of the available electric vehicles 20, 26, 28, 30, 32, 34, the method is continued in a step S14. If the condition of the step S12 has not been met for any of the available electric vehicles 20, 26, 28, 30, 32, 34, the method can be continued in a step S16.

In the step S14, the user is assigned the electric vehicle 20, 26, 28, 30, 32, 34 of the available electric vehicles 20, 26, 28, 30, 32, 34, the actual state of charge of which has met the condition of the step S12. If two or more of the available electric vehicles 20, 26, 28, 30, 32, 34, for example, the electric vehicles 20, 26, 28, meet the condition, the user can be offered, for example, these electric vehicles 20, 26, 28, and therefore the user can select one electric vehicle of the multiple electric vehicles, or further criteria can be taken as a basis for the assignment. For example, the electric vehicle 20, 26, 28 which has the longest downtime and/or the state of charge of which is the lowest, or the state of charge of which is the highest can be preferred in the assignment.

The successful assignment can be communicated, for example, in the form of a message, to the user who has sent the request. The message can be, for example, a written or acoustic message, for example, an SMS, a voice message, or an email or, for example, a push message per app. The message can be sent, for example, to the mobile device 40.

In a step S16, the method can be terminated. If a new request is received, the method can be continued once again in the step S4.

In addition, it is pointed out that “including” does not rule out other elements or steps and “one” does not rule out a plurality. Moreover, it is pointed out that features or steps which have been described with reference to one of the aforementioned exemplary embodiments can also be utilized in combination with other features or steps of other above-described exemplary embodiments. Reference characters in the claims are not to be considered to be a limitation.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

20 first electric vehicle
22 battery
24 battery control unit
26 second electric vehicle
28 third electric vehicle
30 fourth electric vehicle
32 fifth electric vehicle
34 sixth electric vehicle
40 mobile device
50 Internet
60 server
S2-S16 steps two through sixteen

1-13: (canceled)

14. A method for assigning an electric vehicle (20, 22, 24) to a user, the method comprising:
receiving a request from the user via a receiving device indicating that the user needs an electric vehicle (20, 22, 24), the request comprising usage information regarding planned use of the electric vehicle (20, 22, 24);
determining a target state of charge of a battery (22) of at least one available electric vehicle (20, 22, 24) depending on the usage information;
determining an actual state of charge of the battery (22) of the at least one available electric vehicle (20, 22, 24); and
assigning one of the at least one available electric vehicle (20, 22, 24) to the user when the actual state of charge is greater than or equal to the target state of charge.

15. The method of claim 14, wherein determining the target state of charge comprises determining the target state of charge such that the electric vehicle is operable according to the planned use without charging the electric vehicle.

16. The method of claim 14, wherein determining the target state of charge comprises determining the target state of charge such that the electric vehicle (20, 22, 24) requires charging during the planned use when the usage information indicates that the charging does not adversely affect the planned use of the electric vehicle (20, 22, 24).

17. The method of claim 14, wherein:
the usage information comprises personal information indicative of previous driving behavior of the user; and
determining the target state of charge comprises determining the target state of charge depending on the personal information.

18. The method of claim 14, wherein determining the target state of charge comprises determining the target state of charge depending on vehicle information regarding the at least one available electric vehicle (20, 22, 24).

19. The method of claim 14, further comprising determining whether the electric vehicle (20, 22, 24) is available, depending on the usage information, a usage plan for the electric vehicle (20, 22, 24) upon receipt of the request from the user and prior to determining the target state of charge of the battery (22).

20. The method of claim 14, further comprising determining at least two available electric vehicles (20, 22, 24) from a pool (18) of electric vehicles (20, 22, 24, 30, 32, 34) depending on the usage information and depending on a booking plan for the pool (18) upon receipt of the request from the user and prior to determining the target state of charge of the battery (22),
wherein determining the target state of charge of the battery (22) of the at least two electric vehicles (20, 22, 24) comprises determining the target state of charge of the battery (22) of the at least two electric vehicles (20, 22, 24) depending on the usage information,
wherein determining the actual state of charge comprises determining the actual state of charge of the batteries (22) of the at least two electric vehicles (20, 22, 24), and
wherein assigning one of the at least two available electric vehicle (20, 22, 24) to the user comprises assigning the one of the at least two available electric vehicle (20, 22, 24) to the user, the determined actual state of charge of the one of the at least two available electric vehicle (20, 22, 24) being greater than or equal to the determined target state of charge.

21. The method of claim 20, wherein determining the target states of charge of the batteries (22) comprises determining the target states of charge of the batteries (22) depending on the vehicle information indicative of the available electric vehicles (20, 22, 24).

22. The method of claim 20, wherein, when the actual states of charge of more than one of the at least two electric vehicles (20, 22, 24) are greater than or equal to the determined target state of charge, the user is assigned the electric vehicle (20, 22, 24), the state of charge of which is lowest.

23. The method of claim 20, wherein, when the actual states of charge of more than one of the at least two electric vehicles (20, 22, 24) are greater than or equal to the determined target state of charge, the user is assigned the electric vehicle (20, 22, 24), the state of charge of which is highest.

24. The method of claim 20, wherein, when the actual states of charge of more than one of the at least two electric vehicles (20, 22, 24) are greater than or equal to the determined target state of charge, the user is assigned the electric vehicle (20, 22, 24) which has not been used for the longest period of time.

25. The method of claim 14, wherein the battery (22) comprises a lithium-ion battery.

26. A computer program for assigning an electric vehicle (20, 22, 24) to a user, which, when carried out by a processor of a computer, implements the method of claim 14.
